(19) United States
(12) Patent Application Publication
(10) Pub. No.: US 2008/0136809 A1
(43) Pub. Date: Jun. 12, 2008

(54) Liquid crystal displays

(75) Inventors: Chang-Soo Lee, Gyeonggi-do (KR); Young-Soon Lee, Cheonan-si (KR); Min-Cheol Lee, Seoul (KR); Jang-Hyun Yeo, Seoul (KR); Seung-Hwan Moon, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/974,035

(22) Filed: Oct. 10, 2007

(30) Foreign Application Priority Data
Dec. 11, 2006 (KR) 10-2006-0125335

(51) Int. Cl. G09G 5/00

(52) U.S. Cl. 345/214

(57) ABSTRACT

An LCD corrects deviations in pixel kickback voltages caused by delays in gate driving signals. The LCD includes a timing controller generating first and second output enable signals, first and second level shifters respectively generating first and second gate clock pulses and inverted clock pulses, and first and second gate drivers respectively generating first and second gate driving signals. A precharge time of the first gate driving signals is controlled by the pulse width of the first output enable signal and a precharge time of the second gate driving signals is controlled by the pulse width of the second output enable signal.

### RELATED APPLICATIONS

This application claims priority of Korean Patent Application No. 2006-125335, filed Dec. 11, 2006, the entire disclosure of which is incorporated herein by reference.

### BACKGROUND

This disclosure relates to liquid crystal displays (“LCDs”), and, in particular, to LCDs capable of correcting deviations in pixel kickback voltages due to delays in gate driving signals.

LCDs typically include an LCD panel for displaying an image, and gate and data drivers for driving the LCD panel. The LCD panel includes respective pluralities of gate lines, data lines, and pixels, each including a thin film transistor and a liquid crystal capacitor. The data driver supplies data driving signals to the data lines and the gate driver supplies gate driving signals to the gate lines.

The gate driver may be formed on the LCD panel simultaneously with and by the same processes as those used to form the thin film transistors. The data driver is formed in a chip shape that is connected to a peripheral area of the LCD panel. The gate driver includes a shift register, including a plurality of stages, each of which is connected to a corresponding gate line to output the gate driving signals.

The gate driver is connected in cascade to the plurality of gate lines to sequentially supply the gate driving signals to the gate lines. An input terminal of a present stage is connected to an output terminal of a previous stage, and an output terminal of a next stage is connected to a control terminal of the present stage. The input terminal of a first stage receives an opening signal.

The gate driver may include a right gate driver that drives even-numbered gate lines and a left gate driver that drives odd-numbered gate lines. In conventional LCDs, the left and right gate drivers are located much closer to one end of the gate lines than to the opposite ends thereof, and as a result, the gate driving signals experience some delay in traveling to the opposite ends of the gate lines. This delay can result in a deviation in the gate line driving signal experienced by some of the pixels, which in turn, can result in a deviation in pixel kickback voltage, and hence, a deviation in pixel voltage. Therefore, when the left and right gate drivers are located closer to one end of the gate lines than the other, some of the pixels may not exhibit the correct luminance.

### BRIEF SUMMARY

In accordance with the exemplary embodiments described herein, LCDs are provided that overcome the above problem by correcting any deviation of kickback voltage caused by gate driver signal delay.

In one exemplary embodiment, an LCD includes a timing controller generating first and second output enable signals and first and second gate clocks in response to an external input signal, a first level shifter generating a first gate clock pulse and a first gate clock-bar pulse in response to the first output enable signal and the first gate clock, a second level shifter generating a second gate clock pulse and a second gate clock-bar pulse in response to the second output enable signal and the second gate clock, a first gate driver generating a first gate driving signal in response to the first gate clock pulse or the first gate clock-bar pulse, and a second gate driver generating a second gate driving signal in response to the second gate clock pulse or the second gate clock-bar pulse, wherein a “precharge” time of the first gate driving signal is controlled by a pulse width of the first output enable signal and a precharge time of the second gate driving signal is controlled by a pulse width of the second output enable signal.

In another embodiment, the LCD may further include a power supply that supplies a first level voltage and a second level voltage to the first and second level shifters.

In another embodiment, the first level shifter may cause the first gate clock pulse and the first gate clock-bar pulse to swing fully to the respective ones of the first and second level voltages, and the second level shifter may cause the second gate clock pulse and the second gate clock-bar pulse to swing fully to the respective ones of the first and second level voltages.

In another embodiment, the first level voltage may be a gate-on voltage and the second level voltage may be a gate-off voltage.

In another embodiment, the first level shifter may include a first level shifting circuit performing a logical operation on the first output enable signal and the first gate clock and amplifying the voltage level of the result of the operation to generate the first gate clock pulse, and a second level shifting circuit performing a logical operation on the first output enable signal and the first gate clock, inverting the phase of the result of the operation, and amplifying the voltage level of the phase-inverted result to generate the first gate clock-bar pulse.

In another embodiment, the first level shifting circuit may include a logical operator performing an OR operation on the first output enable signal and the first gate clock, a driving inverter inverting the phase of the output of the logical operator and amplifying it, and a full-swing inverter generating the first gate clock pulse of the gate-on and gate-off voltage levels in response to the output of the driving inverter.

In another embodiment, the second level shifting circuit may include a logical operator performing an OR operation on the first output enable signal and the first gate clock, an inversion inverter inverting the phase of the output of the logical operator, a driving inverter inverting the phase of the output of the inversion inverter and amplifying it, and a full-swing inverter generating the first gate clock-bar pulse of the gate-on and gate-off voltage levels in response to the output of the driving inverter.

In another embodiment, the second level shifter may include a first level shifting circuit performing a logical operation on the second output enable signal and the second gate clock and amplifying the voltage level of the result of the logical operation to generate the second gate clock pulse, and a second level shifting circuit performing a logical operation on the second output enable signal and the second gate clock, inverting the phase of the result of the operation, and amplifying the voltage level of the phase-inverted result to generate the second gate clock-bar pulse.

In another embodiment, the first level shifting circuit may include a logical operator performing an OR operation on the second output enable signal and the second gate clock, a driving inverter inverting the phase of the output of the logical operator and amplifying it, and a full-swing inverter generating the second gate clock pulse of the gate-on and gate-off voltage levels in response to the output of the driving inverter.

In another embodiment, the second level shifting circuit may include a logical operator performing an OR operation on the second output enable signal and the second gate clock, an inversion inverter inverting the phase of the output of the logical operator, a driving inverter inverting the phase of the output of the inversion inverter and amplifying it, and a full-swing inverter generating the second gate clock-bar pulse of the gate-on and gate-off voltage levels in response to the output of the driving inverter.

In another embodiment, the first and second gate driving circuits may be integrated into a liquid crystal display panel.

In another embodiment, the input signal may include a vertical synchronization signal, and the timing controller may generate first and second gate start signals in response to the vertical synchronization signal.

In another embodiment, the first level shifter may receive the first gate start signal and generate the first start pulse of the gate-on and gate-off voltage levels, and the second level shifter may receive the second gate start signal and generate the second start pulse of the gate-on and gate-off voltage levels.

In another embodiment, the first gate driver may output the first gate driving signal in response to the first start pulse, and the second driver may output the second gate driving signal in response to the second start pulse.

In another exemplary embodiment, an LCD includes a liquid crystal display panel that includes a plurality of data lines, a plurality of gate lines, and a gate driver sequentially supplying a gate driving signal to the gate lines in response to a gate clock pulse, a data driver driving the plurality of data lines, a level shifter generating the gate clock pulse in response to an output enable signal and a gate clock, and a timing controller that generates the output enable signal and gate clock in response to an external input signal to control the data driver, wherein a precharge time of the gate driving signal is controlled by a pulse width of the output enable signal.

In another embodiment, the gate driver may include a shift register including a plurality of stages connected to each other in cascade.

In another embodiment, the stages have respective output terminals connected to corresponding ones of the gate lines.

In another embodiment, odd-numbered stages may generate the gate clock pulse as the gate driving signal, and even-numbered stages may generate a phase-inverted pulse of the gate clock pulse as the gate driving signal.

In another embodiment, the stages may have input terminals respectively connected to the output terminals of previous stages and control terminals respectively connected to the output terminals of next stages.

In another embodiment, a first one of the stages may have an input terminal receiving a start signal.

A better understanding of the above and many other features and advantages of the kickback voltage deviation correcting LCDs of the present invention may be obtained from a consideration of the detailed description below of some exemplary embodiments thereof, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a plan view functional block diagram of an exemplary embodiment of an LCD in accordance with the present invention;

FIG. 2 is a functional block diagram of a first gate driver of the exemplary LCD of FIG. 1;

FIG. 3 is a circuit diagram of an exemplary stage of the first gate driver of FIG. 2;

FIGS. 4A and 4B are functional block diagrams of exemplary embodiments of first and second level shifters of the exemplary LCD of FIG. 1, respectively, showing respective input and output signals thereof;

FIG. 5 is a circuit diagram of the exemplary first level shifter of FIG. 4A;

FIG. 6 is a timing diagram of input and output signals of the exemplary first level shifter of FIG. 4A; and,

FIG. 7A and FIG. 7B are graphs respectively illustrating kickback voltages in a conventional LCD and an LCD in accordance with an exemplary embodiment of the present invention.

### DETAILED DESCRIPTION

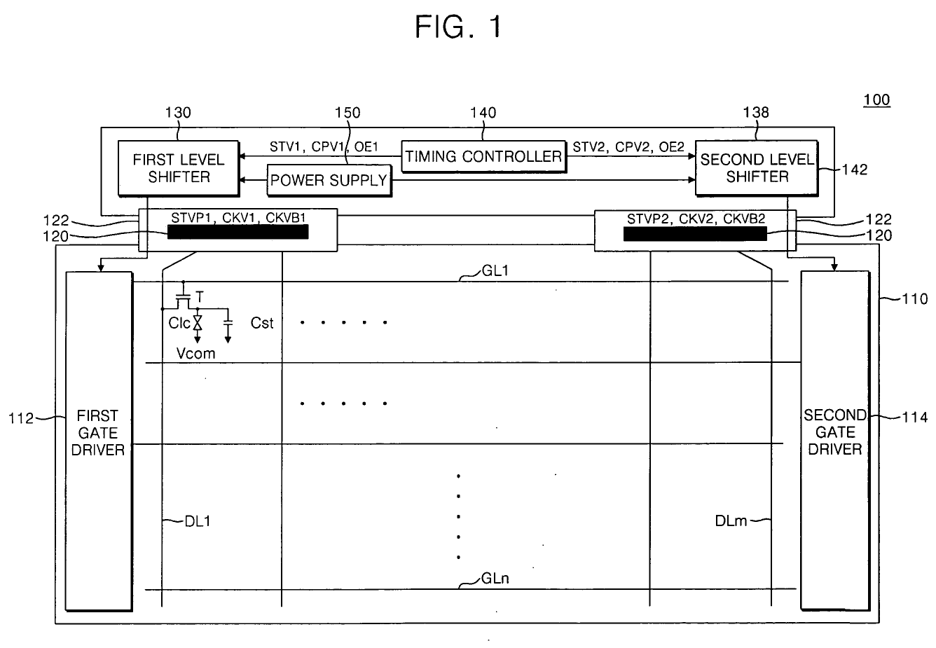

FIG. 1 is a plan view functional block diagram of an exemplary embodiment of an LCD 100 in accordance with the present invention. The LCD 100 includes an LCD panel 110, a data driver 120, first and second gate drivers 112 and 114, first and second level shifters 130 and 138, a timing controller 140, and a power supply 150.

The LCD panel 110 includes a thin film transistor (“TFT”) substrate and a color filter substrate, with a layer of a liquid crystal material disposed therebetween. The TFT substrate includes gate lines GL1 to GLn, data lines DL1 to DLm, a plurality of pixels connected to respective ones of the gate lines GL1 to GLn and the data lines DL1 to DLm, wherein the first and second gate drivers 112 and 114 sequentially drive the gate lines GL1 to GLn.

An exemplary one of the pixels includes a TFT T connected to the gate line GL1 and the data line DL1, a liquid crystal capacitor Clc connected to the TFT T, and a storage capacitor Cst connected to the liquid crystal capacitor Clc. The gate and the source of the TFT T are respectively connected to the gate line GL1 and the data line DL1, and the drain of the TFT T is connected to the liquid crystal capacitor Clc and the storage capacitor Cst. The liquid crystal capacitor Clc is formed between a pixel electrode and a common electrode, with the liquid crystal material functioning as the dielectric material thereof.

The color filter substrate includes a black matrix that prevents leakage of light from the display, a plurality of color filters for displaying colors, and the common electrode. The orientation of the liquid crystals, which have dielectric anisotropy, is controlled by the selective application of different voltages between the common electrode and the pixel electrode, thereby adjusting the transmittance of light through the pixel.

The first and second gate drivers 112 and 114 are integrated onto opposite sides of the LCD panel 110, with the gate lines GL1 to GLn disposed therebetween. Output terminals of the first and second gate drivers 112 and 114 are connected to corresponding ones of the gate lines GL1 to GLn, respectively. It is preferred that the output terminals of the first gate driver 112 are connected to odd-numbered gate lines and the output terminals of the second driver 114 are connected to even-numbered gate lines, but in other embodiments, it is possible that they can be connected in other ways. For example, the first and second gate drivers 112 and 114 may be connected to both ends of respective ones of the gate lines, so that the same gate driving signal is simultaneously supplied to both ends of the gate lines.

The first and second gate drivers 112 and 114 respectively receive start pulses STVP1 and STVP2, gate clock pulses CKV1 and CKV2, and gate clock-bar pulses CKVB1 and CKVGB2 from first and second level shifters 130 and 138 to supply the gate driving signal to the gate lines GL1 to GLn in a sequential manner.

The data driver 120 receives a control signal and image data from the timing controller 140. The data driver 120 selects analog driving voltages corresponding to the image data and supplies them to respective ones of the data lines DL1 to DLm. The data driver 120 may comprise an integrated circuit chip and be mounted on a flexible printed circuit board (“FPC”) 122 connected to the timing controller 140 and the data lines DL1 to DLm.

The first and second level shifters 130 and 138 receive respective start signals STV1 and STV2 and respective gate clocks CPV1 and CPV2 from the timing controller 140, and also receive a driving voltage from the power supply 150. The first and second level shifters 130 and 132 respectively generate the start pulses STVP1 and STVP2, the gate clock pulses CKV1 and CKV2, and the gate clock-bar pulses CKVB1 and CKVB2 and respectively supply those pulses to the first and second gate driver 112 and 114.

The first and second level shifters 130 and 138 control the width of output enable signals OE1 and OE2 and a “precharge” time of the gate clock pulses CKV1 and CKV2 supplied to the first and second gate drivers 112 and 114 through a logic operation with gate clock signals CPV1 and CPV2 in a manner described in more detail below.

The timing controller 140 receives the data and an external input control signal and generates the gate control signal and a data control signal. The timing controller 140 then supplies the gate control signal and the data control signal to the first and second level shifters 130 and 138 and the data driver 120. As used herein, “data” refers to red (“R”), green (“G”), and blue (“B”) image data signals, and the input control signal includes a vertical synchronizing signal, a horizontal synchronizing signal, a main clock, and a data enable signal. The gate control signal includes the output enable signals OE1 and OE2, gate start signals STV1 and STV2, and the gate clocks CPV1 and CPV2 referred to above.

The power supply 150 generates the analog driving voltage, the common voltage VCOM, a gate-on voltage VON, and a gate-off voltage VOFF using an externally supplied power voltage. The power supply 150 supplies the analog driving voltage to the data drive 120, the common voltage VCOM to the common electrode of the LCD panel 110, and the gate-on voltage VON and the gate-off voltage VOFF to the respective ones of the first and second level shifters 130 and 138.

As illustrated in FIG. 1, the timing controller 140, the first and second level shifters 130 and 138, and the power supply 150 are commonly mounted on a control printed circuit board 142. The control printed circuit board 142 is connected to the FPC 122 on which the data driver 120 is mounted. The first and second gate drivers 112 and 114 are formed directly on the LCD panel 110 and may be directly connected to the timing controller 140 through the data driver 120 or the FPC 122.

In the particular exemplary embodiment illustrated in FIG. 1, the first and second gate drivers 112 and 114 are formed in a dual structure and integrated onto opposite sides of the LCD panel 110, with the gate lines GL1 to GLn disposed therebetween.

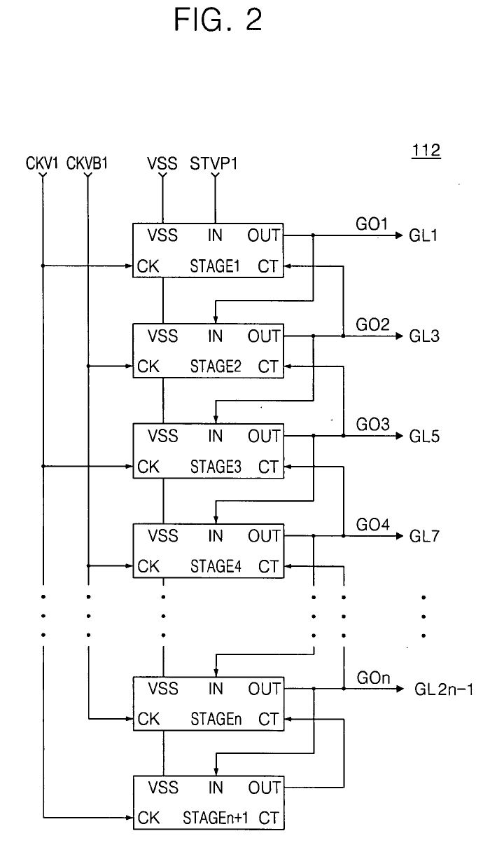

FIG. 2 is a functional block diagram of the first gate driver 112 of the exemplary LCD 100 of FIG. 1. The first gate driver 112 comprises a shift register that includes a plurality of stages STAGE1 to STAGEn+1 dependently connected to each other in cascade fashion. Each of the stages STAGE1 to STAGEn+1 includes a clock terminal CK, an input terminal IN, a control terminal CT, an output terminal OUT, and a ground voltage terminal VSS.

The clock terminals CK of odd-numbered stages STAGE1 to STAGEn+1 receive the gate clock pulse CKV1, and the clock terminals CK of even-numbered stages STAGE2 to STAGEn+2 receive the gate clock-bar pulse CKVB1, which have a phase that is the inverse of that of the gate clock pulse CKV1.

The output terminals OUT of odd-numbered stages STAGE1, STAGE3 to STAGE n+1 output the gate clock pulse CKV1 as the gate driving signal GO1, and the output terminals OUT of even-numbered stages STAGE2 to STAGEn+2 output the gate clock-bar pulse CKVB1 as the gate driving signal GO2. The output terminals OUT of the odd-numbered stages STAGE1 to STAGEn+1 are connected to corresponding odd-numbered gate lines GL1 to GL2n−1 formed on the LCD panel 110. Therefore, the first driver 112 sequentially drives the odd-numbered gate lines GL1 to GL2n−1.

As illustrated in FIG. 2, the input terminals IN of the stages STAGE1 to STAGEn+1 are connected to the output terminals OUT of previous stages and the output signals of the previous stages are applied to the input terminals IN of the plurality of stages STAGE1 to STAGEn+1. The control terminals CT of the plurality of stages STAGE1 to STAGEn+1 are connected to the output terminals OUT of the next stages and the output signals of the next stages are applied to the control terminals CT of the plurality of stages STAGE1 to STAGEn+1. The input terminal IN of the first stage STAGE 1 receives a start pulse STVP1, since no previous stage of the first stage. exists. The last, “dummy” stage STAGEn+1 supplies the output signal to the control terminal CT of an Nth stage STAGEn. Although not shown in FIG. 2, the start pulse STVP1 may be applied to the control terminal CT of the last dummy stage STAGEn+1.

The second gate driver 114 is substantially similar to the first gate driver 112, and therefore, further detailed description thereof is omitted for brevity.

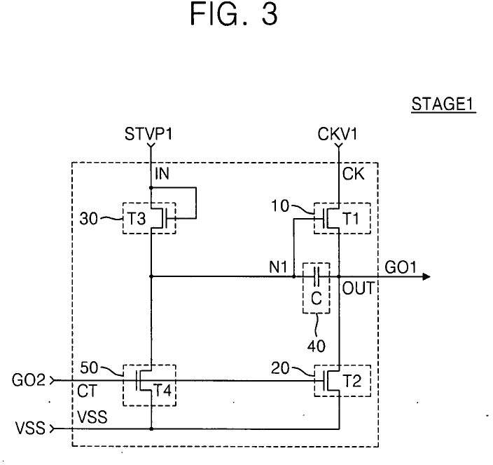

FIG. 3 is a circuit diagram of an exemplary stage STAGE1 of the first gate driver 112 of FIG. 2. The first stage STAGE1 includes a first driver 10, a second driver 20, a buffer circuit 30, an electric charging circuit 40, and an electric discharging circuit 50.

The first driver 10 includes a first transistor T1, and the electric charging circuit 40 includes a capacitor C. The drain of the first transistor T1 is connected to a clock terminal CK, the gate of T1 is connected to one side of the capacitor C via a first node N1, and the source of T1 is connected to the other side of the capacitor and an output terminal OUT. The gate clock pulse CKV1 is inputted to the clock terminal CK.

The second driver 20 includes a second transistor T2, and the buffer circuit 30 includes a third transistor T3. The drain of the second transistor T2 is connected to the source of the first transistor T1 and the other side of the capacitor C, the gate of T2 is connected to a control terminal CT, and the source of T2 is connected to a ground voltage terminal VSS. The drain and gate of the third transistor T3 are connected to the input terminal IN, and the source of T3 is connected to one side of the capacitor C. The start pulse STVP1 is inputted to the input terminal IN.

The electric discharging circuit 50 includes a fourth transistor T4. The drain of the fourth transistor T4 is connected to one side of the capacitor C, the gate of T4 is connected to the control terminal CT in common with the gate of the second transistor T2, and the source of T4 is connected to the ground voltage terminal VSS.

In operation, when the start pulse STPV1 is inputted to the input terminal IN, the third transistor T3 is turned on. The first node N1 potential is then raised to charge the capacitor C. When the charge on the capacitor C exceeds the threshold voltage of the first transistor T1, the first transistor T1 is turned on. Then, the gate clock pulse CKV1 in a high state is supplied through the output terminal OUT to the corresponding gate line GL1 and the input terminal IN of the second stage STAGE2.

Next, when the output signal of the second stage STAGE2 is applied to the control terminal CT, the second transistor T2 is turned on and the ground voltage is applied to the output terminal OUT. The fourth transistor T4 is turned on to discharge the charge on the capacitor C so that the first transistor T1 is turned off. Therefore, the ground voltage is outputted through the output terminal OUT.

The operation of each of the other stages STAGE2 to STAGEn+1 is substantially similar to the operation of the first stage STAGE1, and further detailed description thereof is therefore omitted for brevity.

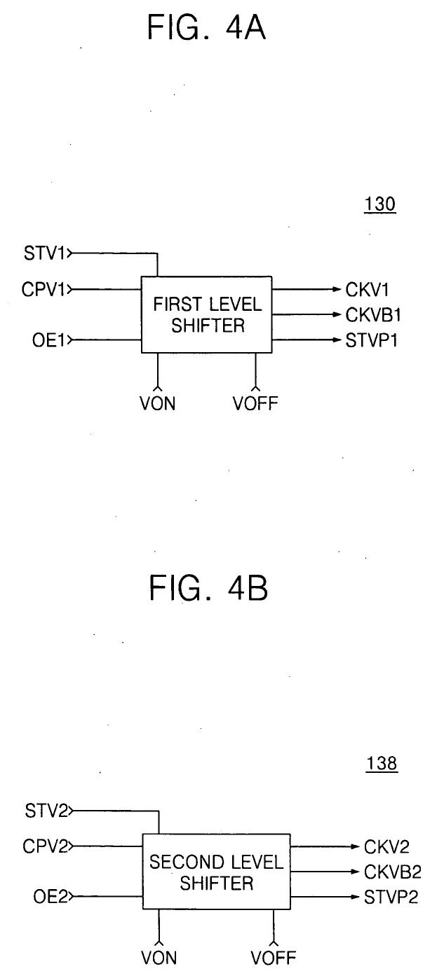

FIGS. 4A and 4B are functional block diagrams of the exemplary first and second level shifters 130 and 138 of the exemplary LCD 100 of FIG. 1, respectively, showing the respective input and output signals thereof.

The first level shifter 130 receives the output enable signal OE1, the gate start signal STV1, and the gate clock CPV1 from the timing controller 140. The first level shifter 130 also receives the gate-on voltage VON and the gate-off voltage VOFF from the power supply 150. The first level shifter 130 generates the start pulse STVP1, the gate clock pulse CKV1, and the gate clock-bar pulse CKVB1 of gate-on and gate-off voltage levels and supplies those pulses to the first gate driver 112.

The second level shifter 138 receives the output enable signal OE2, the gate start signal STV2, and the gate clock CPV2 from the timing controller 140. The second level shifter 138 also receives the gate-on voltage VON and the gate-off voltage VOFF from the power supply 150. The second level shifter 138 generates the start pulse STVP2, the gate clock pulse CKV2, and the gate clock-bar pulse CKVB2 of the gate-on and gate-off voltage levels and supplies those pulses to the second gate driver 114.

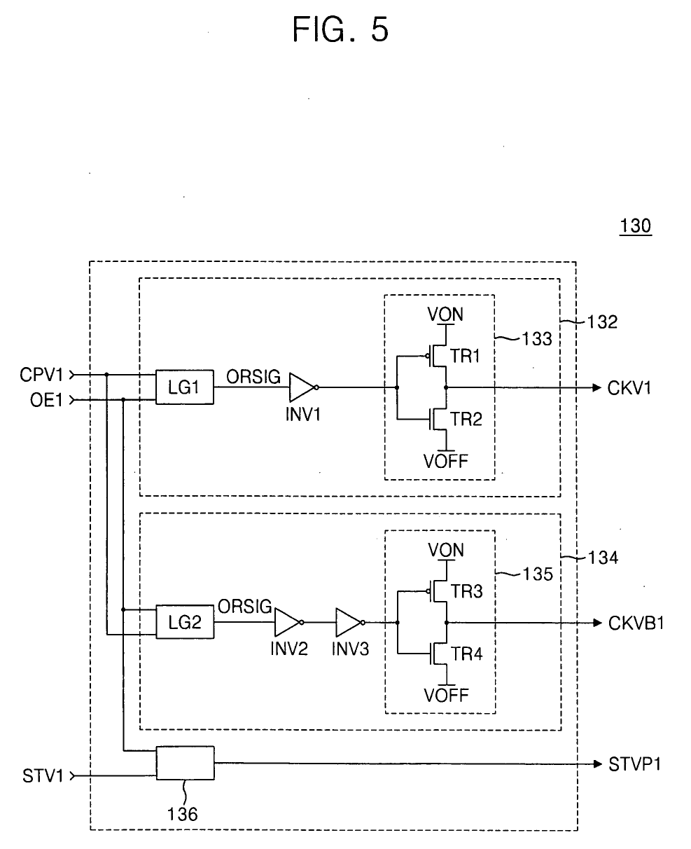

FIG. 5 is a circuit diagram of the exemplary first level shifter 130 of FIG. 4A. As illustrated therein, the first level shifter 130 includes three level shifting circuits 132, 134, and 136.

The first level shifting circuit 132 performs a logical operation on the output enable signal OE1 and the gate clock CPV1 and amplifies the level of the voltage. The first level shifting circuit 132 then generates the gate clock pulse CKV1 and supplies it to the first gate driver 112. The first level shifting circuit 132 includes a first logical operator LG1, a first driving inverter INV1, and a first full-swing inverter 133. In the exemplary embodiments described herein, the output enable signal OE1 may be used as a signal controlling a precharge time of the gate driving signal, which is the output signal of the first gate driver 112.

The first logical operator LG1 performs an OR operation on the output enable signal OE1 and the gate clock CPV1. The first driving inverter INV1 inverts the phase of the output of the first logical operator LG1 and amplifies the inverted output to a level sufficient to drive the first full-swing inverter 133. The first full-swing inverter 133 generates the gate clock pulse CKV1 of the gate-on and gate-off voltage levels in response to the output from the first driving inverter INV1.

The second level shifting circuit 134 performs a logical operation on the output enable signal OE1 and the gate clock CPV2 and amplifies the voltage level of the resulting signal. The second level shifting circuit 134 then generates the gate clock-bar pulse CKVB1 and supplies it to the first gate driver 112. The second level shifting circuit 134 includes a second logical operator LG2, an inversion inverter INV2, a second driving inverter INV3, and a second full-swing inverter 135. The gate clock-bar pulse CKVB1 is the inverted gate clock pulse CKV1.

The second logical operator LG2 performs an OR operation on the output enable signal OE1 and the gate clock CPV1. The inversion inverter INV2 inverts the phase of the output of the logical operator LG1. The second driving inverter INV3 inverts the phase of the output of the inversion inverter INV2 and amplifies the level of the inverted signal to a level sufficient to drive the second full-swing inverter 135. The second full-swing inverter 135 generates the gate clock-bar pulse CKVB1 of the gate-on and the gate-off voltage levels in response to the output of the second driving inverter INV3.

The third shifting circuit 136 receives the output enable signal OE1 and the gate start signal STV1 and generates a start pulse STVP1 of the gate-on VON and gate-off VOFF voltage levels.

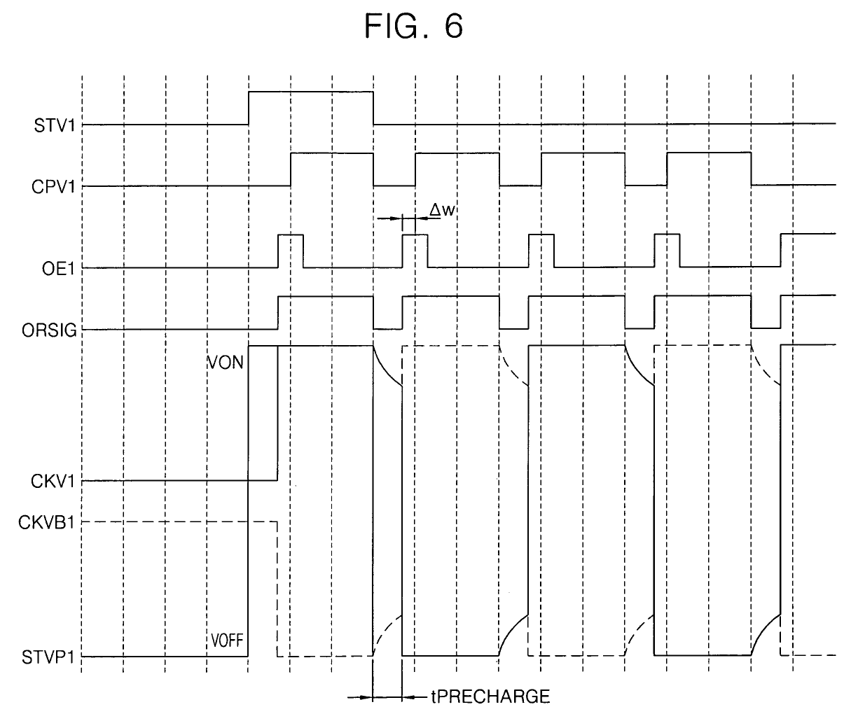

FIG. 6 is a timing diagram of the input and output signals of the exemplary first level shifter 130 of FIG. 5. The functions of the first level shifter 130 are described in detail below with reference to FIG. 6.

An OR signal ORSIG is generated by performing an OR operation on the output enable signal OE1 and the gate clock CPV1. The OR signal ORSIG is amplified to a driving level of the first and second full-swing inverters 133 and 135 so as to drive the first and second full-swing inverters 133 and 135. The first level shifting circuit 132 and the second level shifting circuit 134 then generate the gate clock pulse CKV1 and the gate clock-bar pulse CKVB1 of the gate-on and gate-off voltage levels.

The phase of the OR signal ORSIG is inverted through the inverter INV2, and the inverted OR signal is then amplified to the driving level of the second full-swing inverter 135. The second level shifting circuit 134 then generates the gate clock-bar pulse CKVB1, which has a phase that is opposite to that of the gate clock pulse CKV1. Both the low-level interval of the output enable signal OE1 and the low-level interval of the gate clock CPV1 correspond to a “precharge” time tPRECHARGE of the gate clock pulse CKV1 or the gate clock-bar pulse CKVB1.

The precharge time tPRECHARGE of the gate clock pulse CKV1 or the gate clock-bar pulse CKVB1 may be controlled by the width of the output enable signal OE1. When the width of the output enable signal OE1 is shortened, the precharge time tPRECHARGE of the gate clock pulse CKV1 or the gate clock-bar pulse CKVB1 is increased by the shortened width ΔW of the output enable signal OE1. When the precharge time tPRECHARGE of the gate clock pulse CKV1 and the gate clock-bar pulse CKVB1 is increased, the time during which the pixels are charged with the respective data voltages is increased, so that the kickback voltage ΔV of the pixels is decreased.

The third level shifting circuit 136 generates the start pulse STVP1 of the gate-on and gate-off voltage levels and having the same cycle and pulse width as the gate start signal STV1 in response to the output enable signal OE1.

The construction and operation of the second level shifter 138 is substantially similar to those of the first level shifter 131, and accordingly, further detailed description thereof is omitted for brevity.

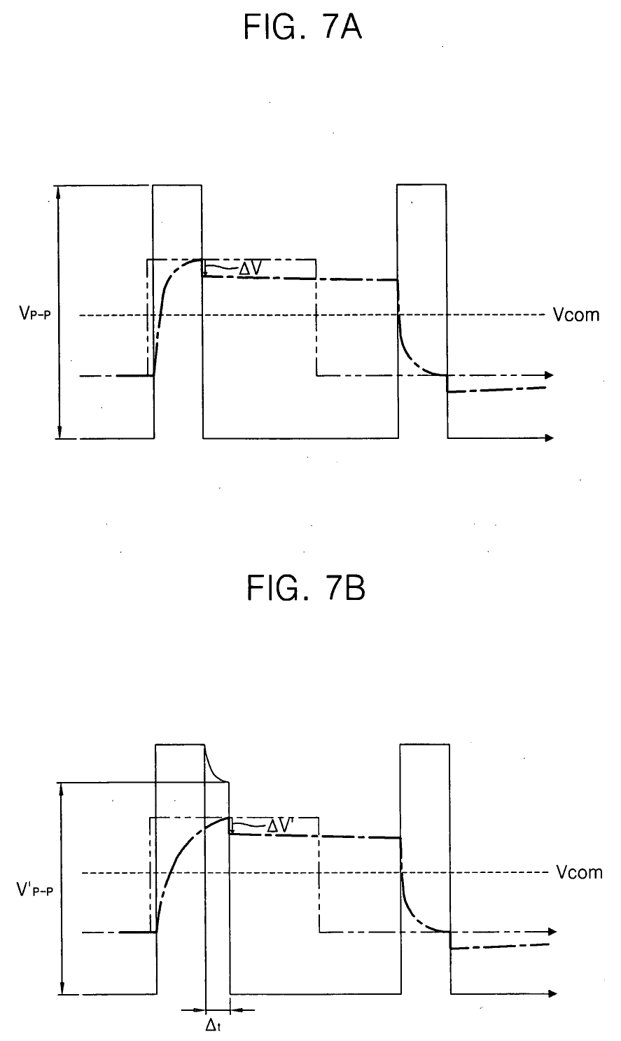

The operation of the exemplary LCD 100 of FIG. 1 is compared with that of a conventional LCD below in connection with FIG. 7A and FIG. 7B, which are graphs respectively illustrating the kickback voltages generated in the conventional LCD and the exemplary LCD 100.

Referring to FIG. 7A, the kickback voltage of the conventional LCD is expressed by the following equation (1).

$$Δ V = \frac{{C}_{gd}}{CLC + CST + {C}_{gd}} \times {V}_{p - p} \qquad ( 1 )$$

In equation (1), CLC is the capacitance of the liquid crystal capacitor, CST is the capacitance of the storage capacitor, Cgd is the capacitance of a coupling capacitor formed by the gate and drain of an associated thin film transistor, and Vp-p is the peak-to-peak value of the gate driving signal.

Referring to FIG. 7B, the kickback voltage of the exemplary LCD 100 of the present invention is expressed by the following equation (2).

$$Δ {V}^{′} = \frac{{C}_{gd}}{{CLC}^{′} + CST + {C}_{gd}} \times {V}_{p - p}^{′} \qquad ( 2 )$$

In equation (2), CLC′ is the capacitance of the liquid crystal capacitor, CST is the capacitance of the storage capacitor, Cgd is the capacitance of a coupling capacitor formed by the gate and drain of an associated thin film transistor, and V′p-p is the peak-to-peak value of the gate driving signal.

In accordance with the present invention, as the precharge interval of the gate driving signal is increased by Δt, the electric charge charged to the liquid crystal capacitor CLC′ is increased and the peak-to-peak value V′p-p of the gate driving signal is decreased. Accordingly, as will be appreciated from Equations (1) and (2) above, the exemplary LCD 100 is therefore capable of substantially reducing the kickback voltage relative to that generated in the conventional LCD.

As described above, the exemplary LCD of the present invention corrects the difference in the kickback voltages caused by a delayed gate driving signal by controlling the precharge time of the gate driving signal. As a result, screen defects generated by the difference of the kickback voltages caused by the delay of the gate driving signal are substantially eliminated.

While this invention has been described in connection with what is presently considered to be practical exemplary embodiments thereof, it should be understood that the scope of the invention is not limited to the particular embodiments described and illustrated herein, as they are only by way of examples thereof, but rather, the scope of the present invention is fully commensurate with the claims appended hereafter and their functional equivalents.

What is claimed is:

1. A liquid crystal display (LCD), comprising:
a timing controller generating first and second output enable signals and first and second gate clocks in response to an outside input signal;
a first level shifter generating a first gate clock pulse and a first gate clock-bar pulse in response to the first output enable signal and the first gate clock;
a second level shifter generating a second gate clock pulse and a second gate clock-bar pulse in response to the second output enable signal and the second gate clock;
a first gate driver generating a first gate driving signal in response to the first gate clock pulse or the first gate clock-bar pulse; and,
a second gate driver generating a second gate driving signal in response to the second gate clock pulse or the second gate clock-bar pulse;
wherein a precharge time of the first gate driving signal is controlled by a pulse width of the first output enable signal and a precharge time of the second gate driving signal is controlled by a pulse width of the second output enable signal.

2. The LCD of claim 1, further comprising a power supply supplying a first level voltage and a second level voltage to respective ones of the first and second level shifters.

3. The LCD of claim 2, wherein:
the first level shifter causes the first gate clock pulse and the first gate clock-bar pulse to swing fully to the first and second level voltages, respectively, and
the second level shifter causes the second gate clock pulse and the second gate clock-bar pulse to swing fully to the first and second level voltages, respectively.

4. The LCD of claim 3, wherein the first level voltage is a gate-on voltage, and wherein the second level voltage is a gate-off voltage.

5. The LCD of claim 4, wherein the first level shifter comprises:
a first level shifting circuit performing a logical operation on the first output enable signal and the first gate clock and amplifying a voltage level of the result of the operation to generate the first gate clock pulse; and,
a second level shifting circuit performing a logical operation on the first output enable signal and the first gate clock, inverting the phase of the result of the operation, and amplifying a voltage level of the phase-inverted result to generate the first gate clock-bar pulse.

6. The LCD of claim 5, wherein the first level shifting circuit, further comprises:
a logical operator performing an OR operation on the first output enable signal and the first gate clock;
a driving inverter inverting the phase of the output of the logical operator and amplifying it; and,
a full-swing inverter generating the first gate clock pulse of the gate-on and gate-off voltage levels in response to the output of the driving inverter.

7. The LCD of claim 5, wherein the second level shifting circuit comprises:
a logical operator performing an OR operation on the first output enable signal and the first gate clock;
an inversion inverter inverting the phase of the output of the logical operator;
a driving inverter inverting the phase of the output of the inversion inverter and amplifying it; and,
a full-swing inverter generating the first gate clock-bar pulse of the gate-on and gate-off voltage levels in response to the output of the driving inverter.

8. The LCD of claim 4, wherein the second level shifter comprises:
a first level shifting circuit performing a logical operation on the second output enable signal and the second gate clock and amplifying the voltage level of the result of the operation to generate the second gate clock pulse; and,
a second level shifting circuit performing a logical operation on the second output enable signal and the second gate clock, inverting the phase of the result of the logical operation, and amplifying the voltage level of the phase-inverted result to generate the second gate clock-bar pulse.

9. The LCD of claim 8, wherein the first level shifting circuit further comprises:
a logical operator performing an OR operation on the second output enable signal and the second gate clock;
a driving inverter inverting the phase of the output of the logical operator and amplifying it; and,
a full-swing inverter generating the second gate clock pulse of the gate-on voltage and gate-off voltage levels in response to the output of the driving inverter.

10. The LCD of claim 9, wherein the second level shifting circuit further comprises:
a logical operator performing an OR operation on the second output enable signal and the second gate clock;
an inversion inverter inverting the phase of the output of the logical operator;
a driving inverter inverting the phase of the output of the inversion inverter and amplifying it; and,
a full-swing inverter generating the second gate clock-bar pulse of the gate-on and gate-off voltage levels in response to an output of the driving inverter.

11. The LCD of claim 1, wherein the first and second gate driving circuits are integrated into a liquid crystal display (LCD) panel.

12. The LCD of claim 11, wherein the input signal comprises a vertical synchronization signal and the timing controller generates first and second gate start signals in response to the vertical synchronization signal.

13. The LCD of claim 12, wherein:
the first level shifter receives the first gate start signal and generates the first start pulse of the gate-on and gate-off voltage levels; and,
the second level shifter receives the second gate start signal and generates the second start pulse of the gate-on and gate-off voltage levels.

14. The LCD of claim 13, wherein the first gate driver outputs the first gate driving signal in response to the first start pulse, and the second driver outputs the second gate driving signal in response to the second start pulse.

15. A liquid crystal display (LCD), comprising:
a liquid crystal display panel having a plurality of data lines, a plurality of gate lines, and a gate driver sequentially supplying a gate driving signal to the gate lines in response to a gate clock pulse;
a data driver driving the plurality of data lines;
a level shifter generating the gate clock pulse in response to an output enable signal and a gate clock; and,
a timing controller that generates the output enable signal and the gate clock in response to an external input signal to control the data driver,
wherein a precharge time of the gate driving signal is controlled by a pulse width of the output enable signal.

16. The LCD of claim 15, wherein the gate driver comprises a shift register that includes a plurality of stages connected to each other in cascade.

17. The LCD of claim 16, wherein the stages have output terminals respectively connected to corresponding ones of gate lines.

18. The LCD of claim 17, wherein odd-numbered stages generate the gate clock pulse as the gate driving signal and even-numbered stages generate a phase-inverted pulse of the gate clock pulse as the gate driving signal.

19. The LCD of claim 18, wherein the stages have input terminals connected to the output terminals of previous stages and control terminals connected to the output terminals of next stages.

20. The LCD of claim 19, wherein a first one of the stages has an input terminal receiving a start signal.
